(19) United States
(12) Patent Application Publication
(10) Pub. No.: US 2025/0100303 A1
(43) Pub. Date: Mar. 27, 2025

(54) DRYING APPARATUS

(71) Applicant: KYOCERA Document Solutions Inc., Osaka (JP)

(72) Inventors: Masaki MURASHIMA, Osaka (JP); Hiroyuki UEDA, Osaka (JP); Minoru TOKONAMI, Osaka (JP); Mitsuhiro GODA, Osaka (JP)

(73) Assignee: KYOCERA Document Solutions Inc., Osaka (JP)

(21) Appl. No.: 18/892,294

(22) Filed: Sep. 20, 2024

(30) Foreign Application Priority Data
Sep. 22, 2023 (JP) 2023-158440

(51) Int. Cl. B41J 13/08; B41J 11/00

(52) U.S. Cl. CPC B41J 13/08; B41J 11/0022

(57) ABSTRACT

A drying apparatus dries a recording medium on which an image is formed, under a high temperature atmosphere while conveying the recording medium, the drying apparatus includes an endless conveying belt, and a roller. The conveying belt supports and conveys the recording medium in a predetermined conveyance direction. The conveying belt is wound around the roller. The roller includes a cylindrical roller body, and flange bodies fitted into both ends of the roller body. In a fitting region between the roller body and the flange body, a thermal expansion coefficient of an inside fitted portion is higher than a thermal expansion coefficient of an outside fitted portion.

### INCORPORATION BY REFERENCE

This application is based on and claims the benefit of priority from Japanese patent application No. 2023-158440 filed on Sep. 22, 2023, which is incorporated by reference in its entirety.

### BACKGROUND

The present disclosure relates to a drying apparatus which dries a recording medium on which an image is formed by an inkjet recording method, under a high temperature atmosphere while conveying the recording medium.

An image forming system including an inkjet type image forming apparatus is provided with a drying apparatus which dries an image formed on a recording medium by ink. The drying apparatus may include a conveying belt wound around a plurality of rollers and traveling by rotation of the rollers. The recording medium supported by the conveying belt is conveyed under a high temperature atmosphere by the circulation of the conveying belt, and the image formed by the ink is dried.

The roller generally includes a cylindrical roller body and flange bodies fitted to both ends of the roller body.

In the above-described drying apparatus, the roller is generally made of metal, and the roller body and the flange body are made of the same material in consideration of torque resistance. In order to prevent the conveyance belt from meandering, a groove may be formed in the flange body along the circumferential direction. Further, there is a requirement that the roller body is made of material having low density in order to reduce a driving torque.

However, in the case where the roller body and the flange body are made of the same material, when a material having low density is selected, the groove for preventing the meandering becomes easily worn, and the durability of the meandering prevention effect may become low. In the case where the roller body and the flange body are made of different materials, such as a case where the flange body is made of material having high hardness and the roller body is made of material having low density, it is necessary to prevent the roller body from idling with respect to the flange body. Therefore, a pinning work for fixing the roller body and the flange body is required, and there is a problem that a number of producing steps increases.

### SUMMARY

A drying apparatus according to the present embodiment dries a recording medium on which an image is formed, under a high temperature atmosphere while conveying the recording medium, the drying apparatus includes an endless conveying belt, and a roller. The conveying belt supports and conveys the recording medium in a predetermined conveyance direction. The conveying belt is wound around the roller. The roller includes a cylindrical roller body, and flange bodies fitted into both ends of the roller body. In a fitting region between the roller body and the flange body, a thermal expansion coefficient of an inside fitted portion is higher than a thermal expansion coefficient of an outside fitted portion.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inside of a drying apparatus according to one embodiment of the present disclosure.

FIG. 2 is a perspective view showing a conveying unit (a conveying belt is not shown), in the drying apparatus according to the embodiment of the present disclosure.

FIG. 3 is a perspective view showing a driving roller of the conveying unit, in the drying apparatus according to the embodiment of the present disclosure.

FIG. 4 is a cross-sectional view showing the driving roller, in the drying apparatus according to the embodiment of the present disclosure.

FIG. 5A is a cross-sectional view showing one end portion of the driving roller, in the drying apparatus according to the embodiment of the present disclosure.

FIG. 5B is a cross-sectional view showing one end portion of the driving roller around which a conveying belt is wound, in the drying apparatus according to the embodiment of the present disclosure.

### DETAILED DESCRIPTION

Hereinafter, with reference to the drawings, a drying apparatus according to one embodiment of the present disclosure will be described.

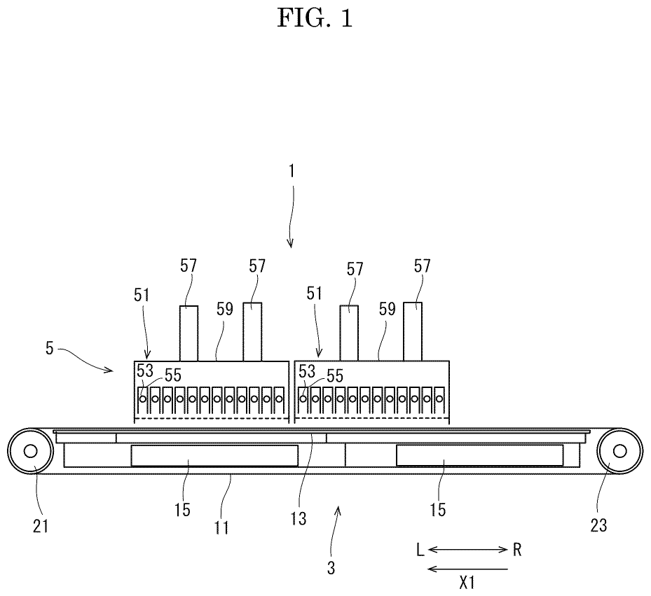

First, with reference to FIG. 1, the entire structure of the drying apparatus 1 will be described. FIG. 1 is a front view schematically showing the inside of the drying apparatus 1. In each figure, Fr, Rr, L and R indicate the front, rear, left and right sides of the drying apparatus 1, respectively.

The drying apparatus includes a conveying unit 3 which conveys a medium (a cut sheets, a long sheet or the like) on which an image is formed by an inkjet method along a conveyance direction X1 (a direction from the right to the left in FIG. 1), and a heating unit 5 which dries the medium conveyed by the conveying unit 3.

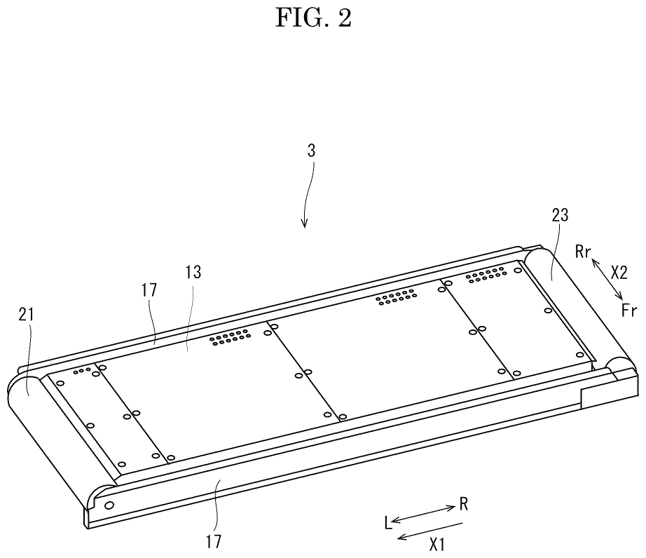

First, the conveying unit 3 will be described with reference to FIG. 1 and FIG. 2. FIG. 2 is a perspective view showing the conveying unit 3 (the conveying belt 11 is not shown). As shown in FIG. 1 and FIG. 2, the conveying unit 3 includes a conveying belt 11 which conveys the medium, a conveying plate 13 which supports the conveying belt 11, a suction device 15 which attracts the medium to the conveying belt 11, and front and rear side plates 17 (see FIG. 2) by which the conveying belt 11, the conveying plate 13 and the suction device 15 are supported.

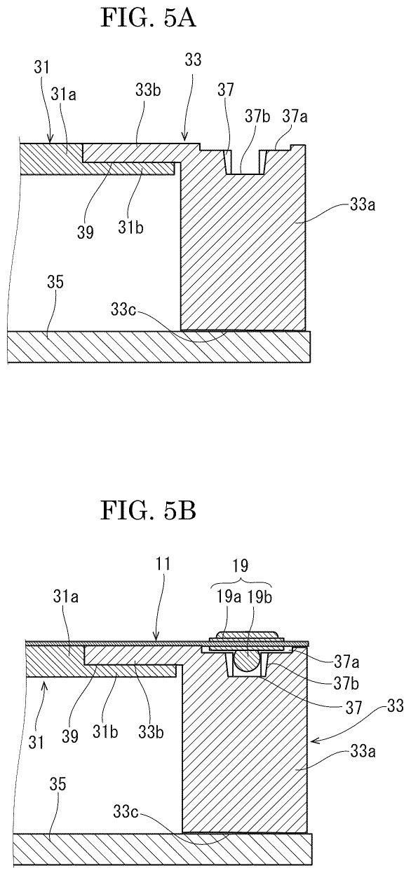

First, the conveying belt 11 will be described. The conveying belt 11 is an endless belt, and a number of through-holes penetrating in the thickness direction are formed on the entire surface. A pin 19 (see FIG. 5B) is fixed to both end portions of the conveying belt 11 in a width direction X2 (in the direction orthogonal to the conveyance direction X1) at predetermined intervals in the circumferential direction. The pin 19 has a disk-shaped head portion 19a and a hemispherical tip portion 19b, and the head portion 19a is fixed to the conveying belt 11 so as to sandwich the conveying belt 11 from the outside and the inside. The tip portion 19b of the pin 19 protrudes inward from the inner circumferential surface of the conveying belt 11. As shown in FIG. 1, the conveying belt 11 is wound around a driving roller 21 and a driven roller 23.

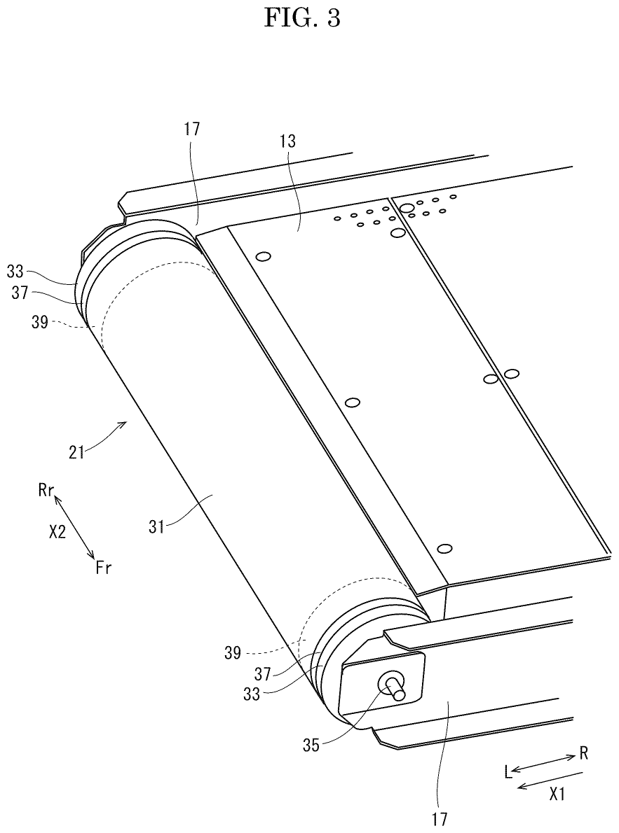

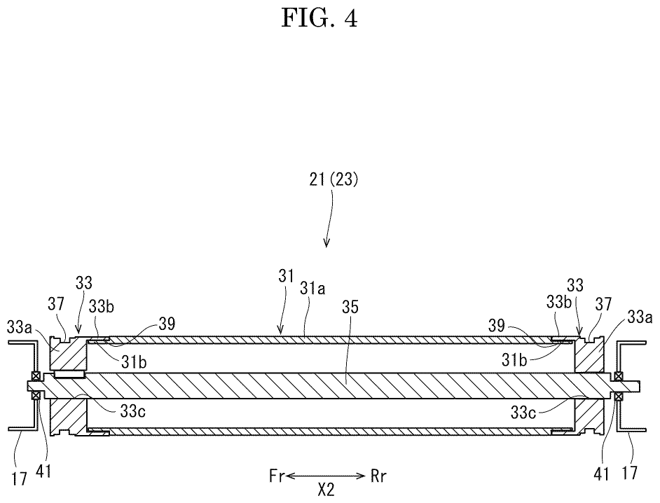

Next, the driving roller 21 and the driven roller 23 will be described with reference to FIG. 3, FIG. 4, FIG. 5A and FIG. 5B. FIG. 3 is a perspective view showing the driving roller 21, FIG. 4 is a cross-sectional view showing the driving roller 21 and the driven roller 23, and FIG. 5A and FIG. 5B are cross-sectional views showing one end of the driving roller 21. Although the driving roller 21 will be mainly described here, the driven roller 23 has the same structure as the driving roller 21.

As shown in FIG. 3 and FIG. 4, the driving roller 21 has a roller body 31, flange bodies 33 fitted to both ends of the roller body 31, and a rotational shaft 35.

First, the roller body 31 will be described. As shown in FIG. 4, the roller body 31 is formed in a cylindrical shape having a constant inner diameter, and includes a main body part 31a having a predetermined outer diameter and cylindrical parts 31b protruding along the inner circumference on the end surfaces of the main body part 31a. That is, an outer diameter of the cylindrical part 31b is smaller than an outer diameter of the main body part 31a, and an inner diameter of the cylindrical part 31b is equal to an inner diameter of the main body part 31a. In order to reduce a driving torque, the roller body 31 is made of material (for example, aluminum) which is relatively light in weight and can reduce inertia during the rotation.

Next, the flange body 33 will be described. As shown in FIG. 4, the flange body 33 has a disk part 33a having a constant thickness and a cylindrical part 33b provided along the outer circumference on one end surface of the disk part 33a. An outer diameter of the cylindrical part 33b of the flange body 33 is equal to an outer diameter of the main body part 31a of the roller body 31, and an inner diameter is equal to an outer diameter of the cylindrical part 31b of the roller body 31. A length of the cylindrical part 33b of the flange body 33 is slightly longer than a length of the cylindrical part 31b of the roller body 31. A through-hole 33c is opened in the center of the disk part 33a.

The flange body 33 is made of material (for example, SUS) having lower coefficient of thermal expansion than that of the roller body 31 and having abrasion resistance. For example, when the roller body 31 is made of aluminum, the thermal expansion coefficient is 23.5 (×10⁻⁶/° C.), and when the flange body 33 is made of SUS304, the thermal expansion coefficient is 19.3 (×10⁻⁶/° C.).

As shown in FIG. 5A, a groove 37 is formed along the circumferential direction on the outer circumferential surface of the disk part 33a. The groove 37 has a shallow portion 37a having a wider width (a length along the longitudinal direction of the roller 21) and a shallow depth, and a deep portion 37b provided in the central portion of the shallow portion 37a and having a smaller width and a deeper depth than the shallow portion 37a.

As shown in FIG. 5A and FIG. 5B, the cylindrical parts 31b of the roller body 31 are respectively fitted into the cylindrical parts 33b of the flange body 33. In the fitting regions 39, the outside fitted portion is the cylindrical part 33b of the flange body 33, and the inside fitted portion is the cylindrical part 31b of the roller body 31. The inner surface of the cylindrical part 33b of the flange body 33 is in contact with the outer surface of the cylindrical part 31b of the roller body 31, and the end surface of the cylindrical part 33b of the flange body 33 is in contact with the end surface of the main body part 31a of the roller body 31. The inner surface of the disk part 33a of the flange body 33 is not in contact with the end surface of the cylindrical part 31b of the roller body 31, and there is a predetermined interval between the two surfaces.

As shown in FIG. 5B, the pins 19 fixed to both ends of the conveying belt 11 are inserted into the grooves 37 of the disk parts 33a of both the flange bodies 33. Specifically, a part of the head portion 19a of the pin 19 (a portion protruding from the inner surface of the conveying belt 11) enters the shallow portion 37a of the groove 37, and the tip portion 19b of the pin 19 enters the deep portion 37b of the groove 37.

Next, the rotational shaft 35 will be described. The rotational shaft 35 is inserted into the through-holes 33c of the disk parts 33a of both the flange bodies 33. As shown in FIG. 4, the rotational shaft 35 is integrally rotatably fixed to one (the front flange body 33 in this example) flange body 33. Both end portions of the rotational shaft 35 are rotatably supported by the front and rear side plates 17 of the conveying unit 3 through bearings 41.

A driving gear (not shown) is fixed to one end of the rotational shaft 35 of the driving roller 21. The driving gear is connected to a motor (not shown) via a gear train. When the motor is driven and the driving gear is rotated through the gear train, the rotational shaft 35 is rotated together with the driving gear. Then, the flange body 33 is rotated together with the rotational shaft 35, and the roller body 31 fitted into the flange bodies 33 is rotated. Thus, the conveying belt 11 wound around both the rollers 21 and 23 travels in the counterclockwise direction of FIG. 1 and FIG. 2. The outer surface of the conveying belt 11 traveling along the upper track becomes the conveying surface on which the medium is conveyed.

Next, the conveying plate 13 will be described with reference to FIG. 1 again. The conveying plate 13 contacts the inner peripheral surface (the surface on the rear side of the conveying surface) of the conveying belt 11 traveling on the upper track to support the conveying belt 11. When the conveying belt 11 travels, the inner peripheral surface of the conveying belt 11 slides along the upper surface of the conveying plate 13. A large number of through-holes penetrating in the thickness direction are formed on the entire surface of the conveying plate 13.

Next, the suction device 15 will be described. The suction device 15 is arranged in the hollow space of the conveying belt 11. When the suction device 15 is driven, air in the through-holes of the conveying belt 11 and the through-holes of the conveying plate 13 is taken in, and the medium is attracted to the conveying surface of the conveying belt 11.

Next, the heating unit 5 will be described with reference to FIG. 1 again. The heating unit 5 includes two heater units 51 arranged above the conveying unit 3 along the conveyance direction X1.

The heater unit 51 has a plurality of infrared heaters 53 arranged side by side in the conveyance direction X1, a reflector 55 for reflecting infrared rays emitted from each infrared heater 53, and two fans 57. The infrared heaters 53 and reflectors 55 are housed in a casing 59 having an open lower surface. Infrared rays emitted from the infrared heaters 53 are reflected by the reflectors 55 and irradiated downward.

The two fans 57 are provided on the top surface of the casing 59. The fan 57 takes in air outside the casing 59 and blows the air toward the inside of the casing 59 below.

The drying operation of the drying apparatus 1 having the above structure will be described. In the conveying unit 3, the motor is driven, the driving roller 21 is rotated, and the conveying belt 11 travels. At this time, the pins 19 at both ends of the conveying belt 11 are inserted into the grooves 37 of the disk parts 33a of the flange bodies 33 of the driving roller 21 and the driven roller 23, so that the conveying belt 11 is prevented from meandering.

Thereafter, the recording medium on which the image is formed by the inkjet method is conveyed to the conveying surface of the conveying belt 11. The suction device 15 is driven. Thereby, as described above, air in the through-holes of the conveying belt 11 and the through-holes of the conveying plate 13 is taken in, and the upper apace of the conveying surface of the conveying belt 11 becomes negative pressure. Then, the recording medium is attracted to the conveying surface. As described above, the recording medium is conveyed along the conveyance direction X1 while being attracted to the conveying surface.

Further, the heated air flow generated by the heating unit 5 is blown on the recording medium conveyed by the conveying belt 11, and the image formed by the ink is dried. The conveying unit 3 disposed below the heating unit 5 is also heated by the heated air flow. That is, the driving roller 21 and the driven roller 23 of the conveying unit 3 are also heated.

As is apparent from the above description, according to the drying apparatus 1 of the present disclosure, each of the rollers 21 and 23 include the roller body 31 and the flange body 33, and the thermal expansion coefficient of the roller body 31 is higher than that of the flange body 33. Therefore, when the rollers 21 and 23 are heated, and the roller body 31 and the flange body 33 thermally expand, an amount of thermal expansion of the roller body 31 becomes larger than an amount of thermal expansion of the flange body 33. In the fitting regions 39 between the roller body 31 and the flange bodies 33, the cylindrical part 31b of the roller body 31 is fitted inside the cylindrical part 33b of the flange body 33. Therefore, when the cylindrical part 31b of the roller body 31 thermally expands radially outwardly in the fitting region 39, the cylindrical part 31b of the roller body 31 is pressed against the cylindrical part 33b of the flange body 33 from the inside, and both the cylindrical parts 31b and 33b come closer together. Thus, idling of the roller body 31 with respect to the flange body 33 can be prevented.

That is, in the case where the flange body 33 is fitted to the roller body 31 by press-fitting, depending on the relationship between the thermal expansion coefficients of the flange body 33 and the roller body 31, when the temperature of the rollers 21 and 23 increases, the inner diameter of the outside fitted portion becomes larger than the outer diameter of the inside fitted portion, and the roller body 31 may idle relative to the flange body 33. In the present disclosure, since the thermal expansion coefficient of the inside fitted portion (the cylindrical part 31b of the roller body 31) is higher than the thermal expansion coefficient of the outside fitted portion (the cylindrical part 33b of the flange body 33), the above-mentioned idling does not occur.

Further, since the roller body 31 is made of a material (in this example, aluminum) which is relatively light in weight and can reduce inertia during the rotation, the driving torque can be reduced. Further, since the flange body 33 is made of a material having abrasion resistance (in this example, SUS), abrasion with the conveying belt 11 can be reduced during the continuous operation. The material of the flange body 33 is preferably harder than the pin 19.

In the fitting region 39, the cylindrical part 33b of the flange body 33 may be fitted inside the cylindrical part 31b of the roller body 31. In this case, in the fitting region 39, the outside fitted portion is the cylindrical part 31b of the roller body 31, and the inside fitted portion is the cylindrical part 33b of the flange body 33. In this case, the thermal expansion coefficient of the material of the flange body 33 is higher than that of the material of the roller body 31. However, when the materials of the roller body 31 and the flange body 33 are selected in consideration of reduction of the driving torque and abrasion of the conveying belt 11 against the pin 19 as described above, it is preferable that the cylindrical part of the roller body 31 is fitted inside the cylindrical part 33b of the flange body 33 as in the present disclosure.

Although the present disclosure has been described in particular embodiments, the present disclosure is not limited to the foregoing embodiments. To the extent that it does not deviate from the scope and object of the present disclosure, the foregoing embodiments may be variously modified, substituted, or modified, and the claims include all embodiments that may fall within the scope of technical thought.

1. A drying apparatus which dries a recording medium on which an image is formed, under a high temperature atmosphere while conveying the recording medium, the drying apparatus comprising:
an endless conveying belt which supports and conveys the recording medium in a predetermined conveyance direction; and
a roller around which the conveying belt is wound, wherein
the roller includes:
a cylindrical roller body, and
flange bodies fitted into both ends of the roller body, and
in a fitting region between the roller body and the flange body, a thermal expansion coefficient of an inside fitted portion is higher than a thermal expansion coefficient of an outside fitted portion.

2. The drying apparatus according to claim 1, wherein
in the fitting region, the roller body is inserted inside the flange body, and
a thermal expansion coefficient of the roller body is higher than a thermal coefficient of the flange body.

3. The drying apparatus according to claim 1, wherein
the flange body has a groove in a circumferential direction to prevent a meandering of the conveying belt.
